(19) United States
(12) Patent Application Publication
(10) Pub. No.: US 2017/0338025 A1
(43) Pub. Date: Nov. 23, 2017

(54) HIGH CURRENT POTTED INDUCTOR AND A METHOD OF MANUFACTURING SAME

(71) Applicant: Warner Power, LLC., Warner, NH (US)

(72) Inventor: Souheil Benzerrouk, Windham, NH (US)

(21) Appl. No.: 15/157,908

(22) Filed: May 18, 2016

(51) Int. Cl. H01F 27/22; H01F 27/24; H01F 27/02; H01F 27/28; H01F 41/02

(52) U.S. Cl. CPC H01F 27/22; H01F 27/2804; H01F 41/02; H01F 27/022; H01F 27/24; H01F 2027/2809

(57) ABSTRACT

A method to construct a high current electronic device such as an inductor or a transformer with a single or multi-layer PCB with split traces and/or laminated bus bars and a high current electronic device built according to these methods. Traces are set-up with cross-overs to ensure the length of all traces is equal to maintain good current sharing. Then, PCBs or bus bars are stacked to provide the turns required for the inductor. Cooling plates are provided to cool the structure which is in turn encapsulated in a potting material.

### CROSS-REFERENCE TO RELATED APPLICATIONS

This application claims priority from U.S. Provisional Patent Application No. 62/271,514 titled “High Current Potted Inductor And A Method Of Manufacturing Same” filed on Dec. 28, 2015 and which is incorporated fully herein by reference.

### TECHNICAL FIELD

The present invention relates to electronic power components and more particularly, relates to high current handling devices such as high current handling power inductors or transformers that are potted in a package and constructed from a single or multi-layer PCB with split traces.

### BACKGROUND INFORMATION

Due to the advances in power electronics and the requirements for higher power factors, more and more demand has been registered for harmonic filter inductors and DC link inductors. Furthermore, due to the introduction of switch mode topologies, many inductive components are subjected to an additional higher frequency component in addition to the lower frequency fundamental or direct current (DC). This high frequency component could span from 1 kHz to several hundred kilohertz.

To this end, many techniques have been employed to both design and manufacture such magnetic components including inductors and transformers. Some of these techniques originated in high frequency magnetic designs with ferrites such as planar designs and Litz wire based designs with several winding configurations. Traditionally in low frequency applications, laminated electric steel cores are employed along with simple winding techniques utilizing either wire or foils and cooling is accomplished through natural convection, forced air, direct and indirect water cooling or in many cases immersion in oil as is the case with electrical distribution transformers.

These devices in general are not well suited to handle higher frequencies due to the substantially increased conductor and core losses. Higher frequency materials are also very limited due to their low saturation flux, therefore a solution to these products will be complex and very expensive.

Accordingly, what is needed is a high current capacity potted inductor and a method of manufacturing the same that is able to manage a low frequency component such as DC, as well as AC and high frequency components in the conductor, as well as a thermal management structure to efficiently remove heat from the device thereby reducing the surface temperature of the structure.

### SUMMARY

### Brief Description of the Drawings

These and other features and advantages of the present invention will be better understood by reading the following detailed description, taken together with the drawings wherein:

FIG. 1 is a perspective view of an assembled high current potted inductor in accordance with the teachings of the present invention; and

FIG. 2 is an exploded view of the high current inductor of FIG. 1 in accordance with the present invention;

FIG. 3 is an exploded view of the high current inductor FIG. 1 without the potting material in place;

FIG. 4 is an exploded schematic view of a printed circuit boards stack showing the structure of the printed circuit board forming the high current device according to the present invention;

FIG. 5 is an exploded view of multiple printed circuit boards utilized to form a single winding of a high current device in accordance with the teachings of the present invention;

FIG. 6 is a schematic diagram illustrating the split trace with crossover set out on a printed circuit board in accordance with the teachings of the present invention;

FIG. 7 is a schematic diagram of the multilayer configuration of a multilayer printed circuit board utilized for constructing the high current potted inductor according to the present invention;

FIG. 8 is an exploded view of multiple laminations used to create a single winding turn for a potted inductor in accordance with the teachings of the present invention; and

FIG. 9 is a schematic exploded view of a foil wound inductor layered between 2 cooling plates in accordance with another embodiment of the present invention.

### DETAILED DESCRIPTION OF THE PREFERRED EMBODIMENTS

When a conductor such as copper is subjected to DC current, the current flows uniformly though the whole surface area. In this case the only parameters that influence its resistance are related to material properties and physical dimensions of the conductor as may be describe in the following equation:

$$R = \frac{l}{σ A} \qquad Equation 1$$

Where l is the length of the conductor, σ is the electric conductivity (for example 5.8 10⁻⁷ S/m in copper) and A is the cross-sectional area of the conductor.

When AC or an AC component of current is present such in the case of DC-Link inductors, harmonic mitigation inductors, or in AC reactors, the situation can be very different. The AC component of the current creates a magnetic field around it which subsequently induces an electric field based on Faraday's law. The electric field results in a current flow through the center of the conductor opposite in direction to the initial (desired) current. This phenomenon forces the current to flow on the surface of the conductor based on a factor called skin-depth which is related to the frequency and material conductivity as set out in Equation 2 below:

$$δ = \frac{1}{\sqrt{μπ f σ}} \qquad Equation 2$$

Wherein δ is the skin depth in mm, μ the magnetic permeability of the material, f the frequency and σ the electric conductivity.

In heavy current applications, a typical design involves either a multi-strand conductor or a multi-sheet copper circuit to achieve the desired current density and carrying capacity. This requirement, in addition to the number of physical “turns” of the conductor within the device, results in a number of conductors carrying a large current in close proximity to one another. This fact results in an additional induced current opposite to the main or desired current flow which increases the AC resistance of the conductor by a specific factor related to the skin-depth and the distance between conductors. This phenomenon is called proximity effect and is described through the Dowell's Method where the ratio of the AC resistance and the DC resistance in a foil design is computed as follows:

$$\frac{{R}_{AC}}{{R}_{DC}} = γ \frac{sinh 2 γ + sin 2 γ}{cosh 2 γ - cos 2 γ} + \frac{2}{3} ( {m}^{2} - 1 ) \frac{sinh γ - sin γ}{cosh γ + cos γ} \qquad Equation 3$$

wherein γ=d/δ and is the ratio between the thickness of the conductor “d” and the skin depth, and m is the number of layers.

To minimize the ratio of R_{AC} to R_{DC}, many techniques have been employed in high frequency applications such as planar inductors and transformers where the inductor is embedded in the PCB and the windings are traces therein. This approach works well when the PCB trace is a single, solid trace. For high current however, this is not possible and a multitude of parallel traces are required. Moreover, if the trace is too wide, the current tends to flow in the shortest path and crowds in the region closest to the core (concentrically).

The current invention addresses these limitations for inductors, reactors, and chokes that are subject to a DC (such as DC-link inductors) or low frequency component combined with a high frequency component either due to a high harmonic content or a switching stage such as an inverter or power factor correction stage. The invention focuses on balancing a design that mitigates losses considerably by employing a unique winding scheme to manage DC, AC and high frequency losses in the conductor and a thermal management structure to efficiently remove the heat from the inductor thereby reducing the surface temperature of the structure.

This invention proposes a method to construct a large current inductor or a transformer with a single or multi-layer PCB with split traces. Traces are set-up with cross-over to ensure the length of all traces is equal to maintain good current sharing. Then, PCBs are stacked to provide the turns required for the inductor. Cooling plates are provided to cool the structure which is in turn encapsulated in a potting material.

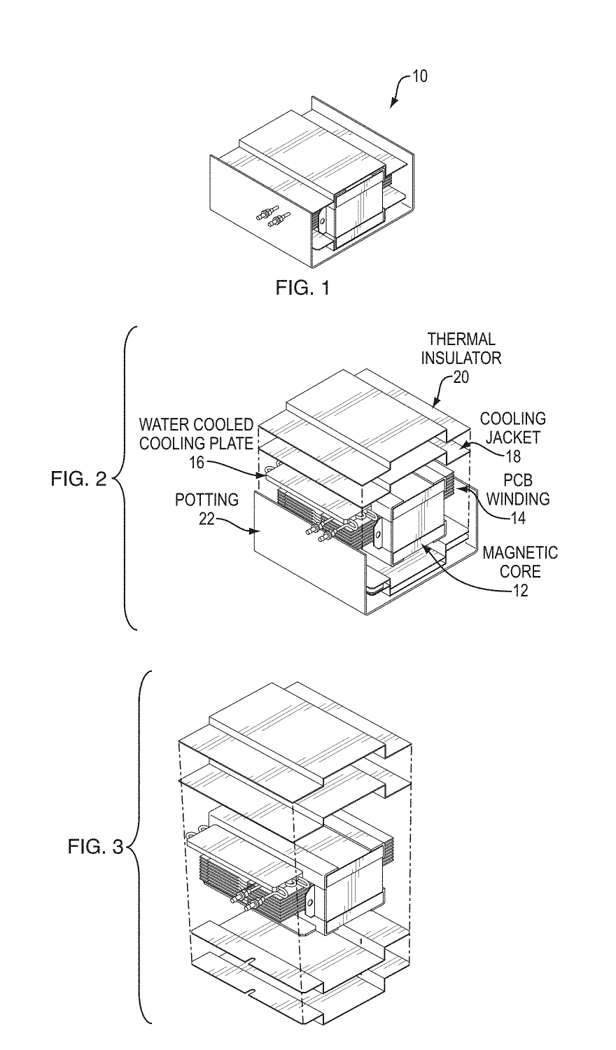

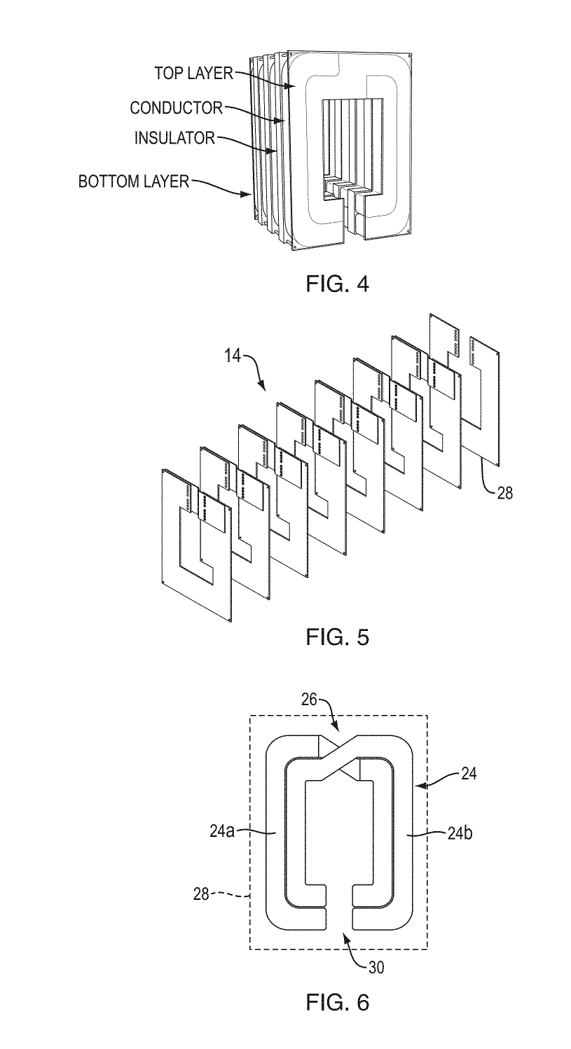

In a first embodiment of the present invention, a high current inductor or other similar type of high current electronic device such as a transformer 10, FIG. 1, is constructed as a potted device having a magnetic core 12, FIG. 2, a planar type winding 14 (explained in greater detail below), a fluid cooling path 16 in the form of a cooling plate (for example, a cooling structure or jacket) and a thermal insulation layer 20. The component 10 is encased in an epoxy or other similar encapsulant forming “potting” 22 as well known in the art.

In one embodiment, the inductor FIG. 10 is of a “shell” type core construction such that the magnetic core 12 is outside the conductor and “sandwiches” the windings 14. In this case, the core 12 is of a three legged construction with a center leg 38, FIG. 12, over which the winding 14 (having a central opening 40) fits. The inductor may also be of a core-type construction FIG. 11. Both shell type and core-type transformer constructions are well known in the art and considered to be within the scope of the present invention.

The winding 14 is preferably a planar type winding wherein each “turn” of the winding is located on a printed circuit board (PCB) 28, FIG. 5. Each winding is split into a multitude of traces 24 (for example, two such traces 24a, 24b shown in FIG. 6) with a cross-over portion 26 to equalize the “length” of the traces on the PCB 28 and hence equalizing the DC resistance with the result to reduce the proximity effect between “turns” on the PCB 28 and between PCB layers 28.

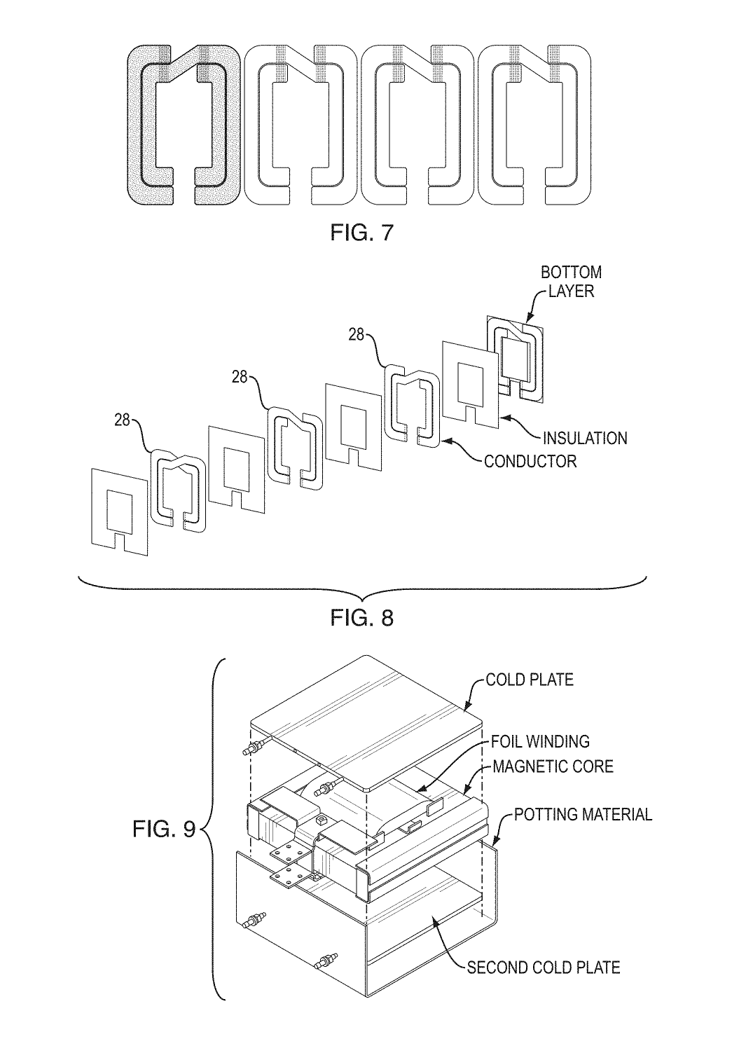

In the first embodiment, the high current inductor windings formed on a PCB has a multitude of layers or PCBs 28 (a multi-layer PCB is well known in the art), each layer with a multitude of traces 24. Additional PCB layers 28 provide conductors to increase current carrying capacity. PCB layers 28 are parallel with connections only at the start of the winding 30 and at the cross-over point 26. The PCBs 28 are then connected to each other though connector pieces at the start of the winding 30 and at the cross-over point 26 to provide a continuous loop of conductor. Each turn may include a multitude of layers 28 (FIGS. 5 and 8) and each layer 28 may include a multitude of traces 24 with a cross-over 26. Thermal vias (not shown but well known) may be provided to allow for trace cross-over and provide additional cooling to the conductor. Multilayer printed circuit boards and multilayer substrates for ball grid array packages are well known. Smaller transformers (½″ to 3″ in size handling 200 watts of power) typically do not require trace cross-over while larger transformers handling 200K watts and 1000 amps will utilize cross-overs and will provide a transformer with very little temperature rise.

In order to create electrical interconnections between the different metal layers 28, vias are provided. In most cases, vias are hollow cylinders of copper, created by plating a thin layer on the inside surface of a hole drilled through the laminated metal and dielectric layers of the PCB 28. Vias not only provide an electrical path through the dielectric layers but also an enhanced thermal path for heat flow.

In the preferred embodiment, the high current inductor further includes at least one fluid cooling device (i.e. a water cooled cold plate) 16. The cooling device may be a tubing loop and preferably a water cooled cold plate 16. A cooling jacket 18 may be provided to transport heat from the winding(s) 14 into the cold plate 16. The cooling jacket 18 can be constructed of any thermally conductive material such as copper, silver or graphite.

The high current inductor with a cooling jacket 18 may be preferably further isolated from the potting 22 through a layer of thermal insulation 20 to improve thermal transfer to the cooling fluid and also serves to further insulate the surface of the thermal jacket 20 from the outer surface of the inductor.

Thus, a high current potted inductor built and assembled according to the teachings of the present invention provides structural integrity and improves thermal performance.

In a second embodiment, an inductor or similar device made in accordance with the first embodiment of the invention is provided with the winding 14 created by laminated bus bars 28 as shown in FIG. 8. Laminated bus bars are engineered components comprising of layers of fabricated copper separated by thin dielectric materials, laminated into a unified structure. Each bus bar 28 is designed and structured similar to a PCB to manage skin depth and proximity effects of magnetics.

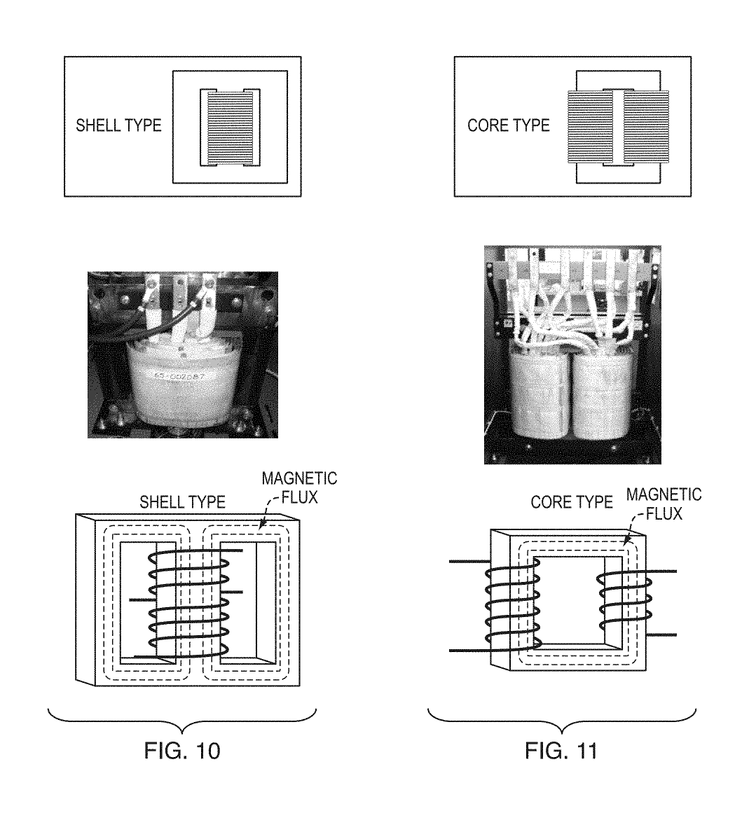

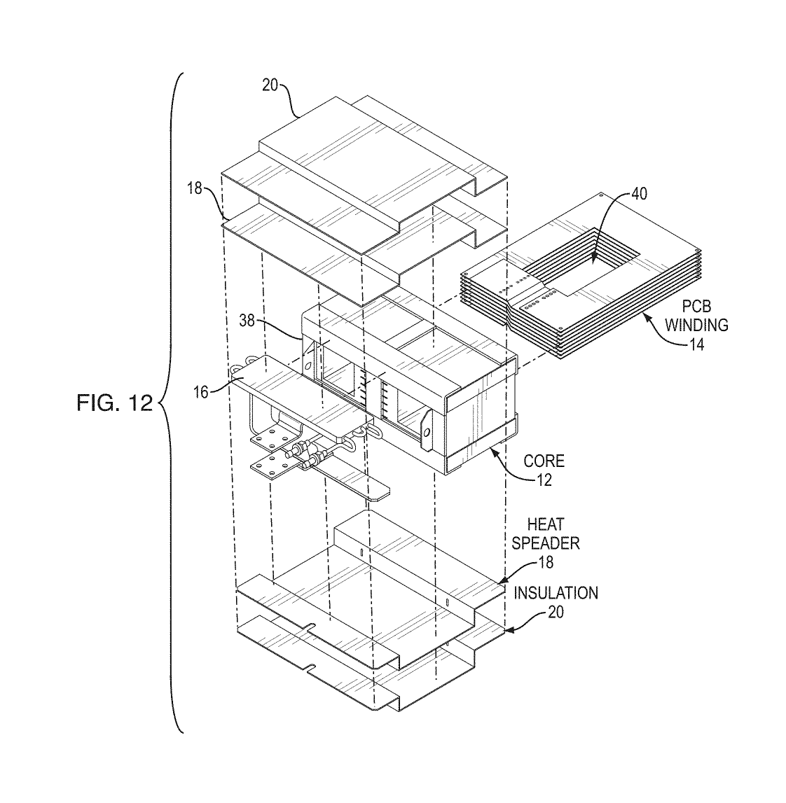

In a third embodiment, the inductor or similar device made in accordance with the teachings of the present invention may be constructed with the winding 14 created by using copper foil. The inductor may be constructed with the foil winding between two cold plates (FIG. 9) to provide cooling for the full structure.

The inductor in the third embodiment with the cold plates is attached to the windings to maintain a cooling to the outer surface and guarantee that all heat is transferred to the water including the temperature rise due to the core and gap structures.

Accordingly, the present invention provides a method to construct a high current electronic device such as an inductor or a transformer utilizing a single or multi-layer PCB with split traces or laminated bus bars and a high current electronic device built according to these methods. Traces are set-up with cross-overs to ensure the length of all traces is equal to maintain good current sharing. Then, PCBs are stacked to provide the turns required for the inductor or bus bars laminated as required. Cooling plates are provided to cool the structure which is in turn encapsulated in a potting material

Modifications and substitutions by one of ordinary skill in the art are considered to be within the scope of the present invention, which is not to be limited except by the allowed claims and their legal equivalents.

The invention claimed is:

1. A high current electronic device comprising:
a high current inductor device, said high current inductor device including top and bottom planar surfaces and first and second lateral side portions, said high current inductor device comprising:
a magnetic core;
an inductor winding;
first and second heat conductive elements, disposed in contact with said first and second lateral side portions of said high current inductor;
at least one fluid activated cooling device disposed in contact with at least one of said first and second lateral side portions of said high current inductor;
first and second thermally conductive members, said first thermally conductive member disposed in contact with said top planar surface of said high current inductor, and said second thermally conductive member disposed in contact with said bottom planar surface of said high current conductor, at least one of said first and second thermally conductive members disposed in contact with said at least one fluid activated cooling device;
first and second thermally insulating members, said first thermally insulating members disposed in contact with said first thermally conductive member and said second thermally insulating member disposed in contact with said second thermally conductive member;
an enclosure, configured for containing said high current inductor; and
a quantity of potting material, disposed in said enclosure, and configured for encapsulating said high current inductor in said enclosure and for providing structural integrity and improving thermal performance of said high current inductor.

2. The high current electronic device of claim 1, wherein the high current electronic device includes a shell type inductor wherein the magnetic core is a shell core surrounding the winding, and wherein said magnetic core is disposed outside the conductor.

3. The high current electronic device of claim 1, wherein the winding is a planar type winding forming a plurality of turns, and wherein each turn is disposed on a printed circuit board (PCB).

4. The high current electronic device of claim 3, wherein each turn of the planar type winding is split into a plurality of traces, each of said plurality of traces having a cross-over region configured to equalize the length of the traces on a given PCB and to reduce the proximity effect between turns and between layers.

5. The high current electronic device of claim 3, wherein the PCB comprises a plurality of layers on a corresponding plurality of PCBs, and wherein each layer comprises a plurality of traces on one PCB, and wherein the plurality of PCB layers each include an electrical connection at a starting point of the winding and at a crossover point in the winding.

6. The high current electronic device of claim 3, wherein the winding includes a plurality of PCBs, and wherein the plurality of PCBs are connected to each other though conductive connector pieces to provide a continuous loop of conductor.

7. The high current electronic device of claim 3, wherein said high current electronic device includes a single PCB having a plurality of turns incorporated on said single PCB, and wherein each turn further includes a plurality of layers and wherein each of said plurality of layers includes a plurality of traces, each of said plurality of traces having a cross-over region.

8. The high current electronic device of claim 7, wherein said single PCB further includes a plurality of thermal vias configured for allowing for trace cross-over and for providing additional cooling to the high current inductor.

9. The high current electronic device of claim 1, wherein said fluid containing cooling device includes a fluid cooling device comprising a fluid containing tubing loop.

10. The high current electronic device of claim 9, wherein the fluid containing cooling device is a cold plate.

11. The high current electronic device of claim 1, wherein said first and second thermally conductive members are constructed of a thermally conductive material selected from the group of thermally conductive materials consisting of copper, silver and graphite.

12. The high current electronic device of claim 11, wherein the fluid containing cooling device is thermally isolated from the potting material through a layer of thermal insulation configured to improve thermal transfer to fluid in the fluid containing cooling device, and further thermally insulated from a surface of the first and second thermally insulating members.

13. The high current electronic device of claim 1, wherein the high current electronic device includes a core type inductor.

14. The high current electronic device of claim 1, wherein the winding is a planar type laminated bus bar winding comprising a plurality of layers of fabricated copper separated by at least one layer of thin dielectric material, all said layers of fabricated copper and thin dielectric material laminated into a unified structure.

15. A method of making a high current electronic device,
said method comprising the acts of:
providing a high current inductor device, said high current inductor manufactured according to the acts of:
providing a magnetic core and an inductor winding, said high current inductor including top and bottom planar surfaces and first and second lateral side portions;
providing first and second heat conductive elements, disposed in contact with said first and second lateral side portions of said high current inductor;
providing at least one fluid activated cooling device disposed in contact with at least one of said first and second lateral side portions;
providing first and second thermally conductive members, said first thermally conductive member disposed in contact with said top plane or surface of said high current inductor, and said second thermally conductive member disposed in contact with said bottom planar surface of said high current conductor, at least one of said first and second thermally conductive members disposed in contact with said at least one fluid activated cooling device;
providing first and second thermally insulating members, said first thermally insulating members disposed in contact with said first thermally conductive member and said second thermally insulating member disposed in contact with said second thermally conductive member;
providing an enclosure, configured for containing said high current inductor; and
providing a sufficient quantity of potting material, disposed in said enclosure, and configured for encapsulating said high current inductor in said enclosure.
